(19) United States
(12) Patent Application Publication
(10) Pub. No.: US 2014/0085052 A1
(43) Pub. Date: Mar. 27, 2014

(54) MODULAR RFID TAG SCANNER FOR A PRODUCT STORAGE SYSTEM

(71) Applicants: Interstate Battery System International, Inc., Dallas, TX (US); Seeonic, Inc., Plymouth, MN (US)

(72) Inventors: Nicholas Singh, Apple Valley, MN (US); Bruce Hellen, Woodinville, WA (US)

(73) Assignees: Interstate Battery System International, Inc., Dallas, TX (US); Seeonic, Inc., Plymouth, MN (US)

(21) Appl. No.: 14/040,512

(22) Filed: Sep. 27, 2013

Related U.S. Application Data
(60) Provisional application No. 61/706,588, filed on Sep. 27, 2012.

(51) Int. Cl. G06K 7/10

(52) U.S. Cl. CPC G06K 7/10316
USPC 340/10.1; 29/601

(57) ABSTRACT

A modular RFID tag scanner includes a control unit and multiple signal distribution units. The signal distribution units include multiple antennas within a single housing. The signal distribution units are each connected to the control unit by an RF transmission line. The configuration of the modular RFID tag scanner permits easy construction or retrofitting of a product storage structure to scan RFID tags on products, such as to monitor product inventory on the product storage structure. Methods of installing and using an RFID tag scanner are also disclosed.

### CROSS REFERENCE TO RELATED APPLICATION

This application claims priority to U.S. Provisional Application Ser. No. 61/706,588 filed on Sep. 27, 2012, entitled MODULAR RFID TAG SCANNER FOR A PRODUCT STORAGE SYSTEM, the disclosure of which is incorporated by reference herein in its entirety.

### BACKGROUND

Product inventory is often tracked in retail and other environments using point of sale systems. Unfortunately, such systems often have a high error when inventory data is compared to the actual inventory of products within the retail store. As a result, inventory often must be checked manually, by physically counting products on the shelves, or by using handheld barcode readers or handheld radio frequency identification (RFID) tag scanners. A major drawback to using such handheld devices is the manual labor required. As a result, such manual inventory processes are typically conducted infrequently, such that actual product inventory at any given time is often uncertain.

### SUMMARY

In general terms, this disclosure is directed to a modular RFID tag scanner that can be used for an existing product storage system to read RFID tags of products stored in the product storage system.

One aspect is a modular radio frequency identification (RFID) tag scanner for a product storage structure, the scanner comprising: one or more signal distribution units comprising: a switching device; antennas configured to wirelessly communicate with RFID tags on products stored in the product storage structure; antenna transmission lines connecting the antennas to the switching device; and a housing enclosing the switching device, antennas, and radio frequency (RF) transmission lines therein; and fasteners configured to connect the one or more signal distribution units to the product storage structure adjacent the products; one or more control wires configured to be electrically coupled to each of the one or more signal distribution units; a control unit operable to control the switching devices through the control wires to selectively communicate with the antennas of the one or more signal distribution units and to detect RFID tags on products stored in the product storage structure; and one or more RF transmission lines configured to be connected between the signal distribution units and the control unit.

Another aspect is a method of installing an RFID tag scanner on a product storage structure having product storage regions, the method comprising: inserting signal distribution units into each of the product storage regions and fastening the signal distribution units with a fastener, wherein the signal distribution units include multiple antennas, antenna transmission lines connected to each antenna, and an RF switch all contained within a housing; connecting a control unit to the product storage structure; and connecting RF transmission lines and control wires between the control unit and the signal distribution units.

### BRIEF DESCRIPTION OF THE DRAWINGS

FIG. 1 is a schematic block diagram of an example modular RFID tag scanner according to the present disclosure.

FIG. 2 is a schematic cross-sectional diagram illustrating an exemplary signal distribution unit of the modular RFID tag scanner shown in FIG. 1.

FIG. 3 is a schematic block diagram of an exemplary control unit of the modular RFID tag scanner shown in FIG. 1.

FIG. 4 illustrates an example of a retail battery story structure in which the modular RFID tag scanner shown in FIG. 1 can be implemented.

FIG. 5 illustrates an example of a delivery vehicle in which the modular RFID tag scanner shown in FIG. 1 can be implemented.

FIG. 6 is a schematic block diagram illustrating use of an intermediary switch according to the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

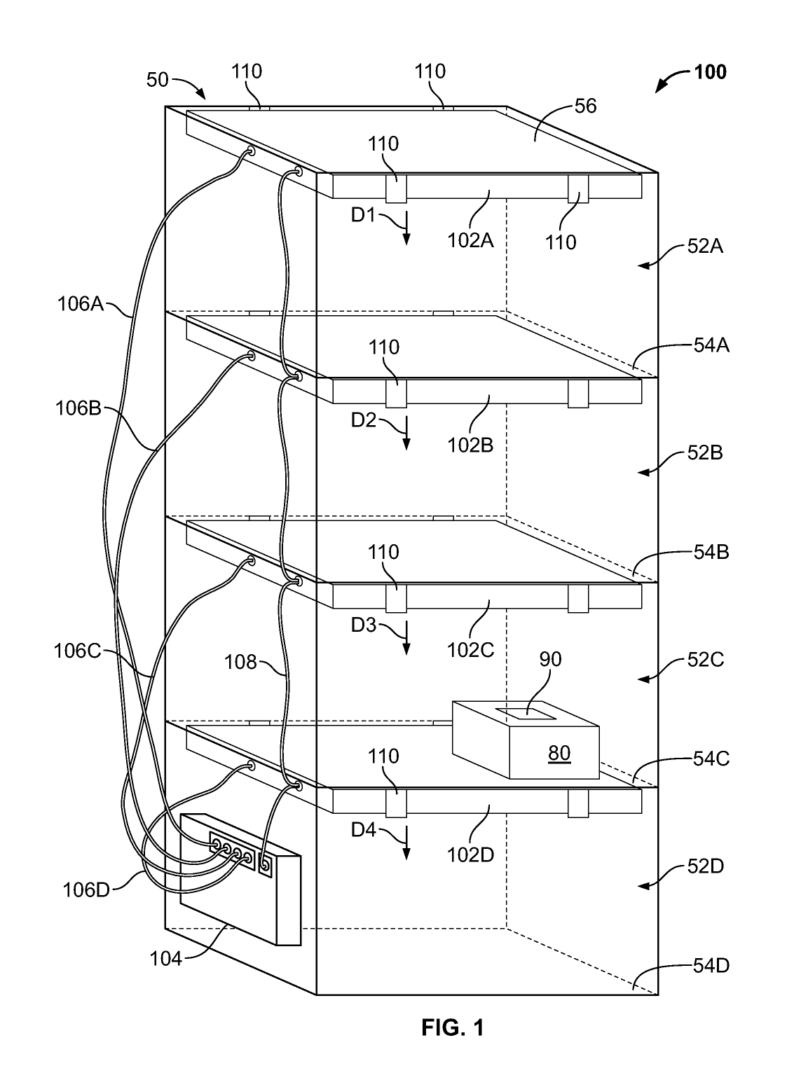

FIG. 1 is a schematic block diagram of an example modular RFID tag scanner 100. In this example, the modular RFID tag scanner 100 includes signal distribution units 102 (including signal distribution units 102A-D), a control unit 104, radio frequency (RF) transmission line 106 (including RF transmission lines 106A-D), control wires 108, and fasteners 110. Also shown in FIG. 1 is an example of a product storage structure 50 and an example product 80.

The modular RFID tag scanner 100 is configured to be connected to be installed on and connected to a product storage structure 50. The example product storage structure 50 is illustrated in a schematic and somewhat transparent form to more clearly depict features of the modular RFID tag scanner 100.

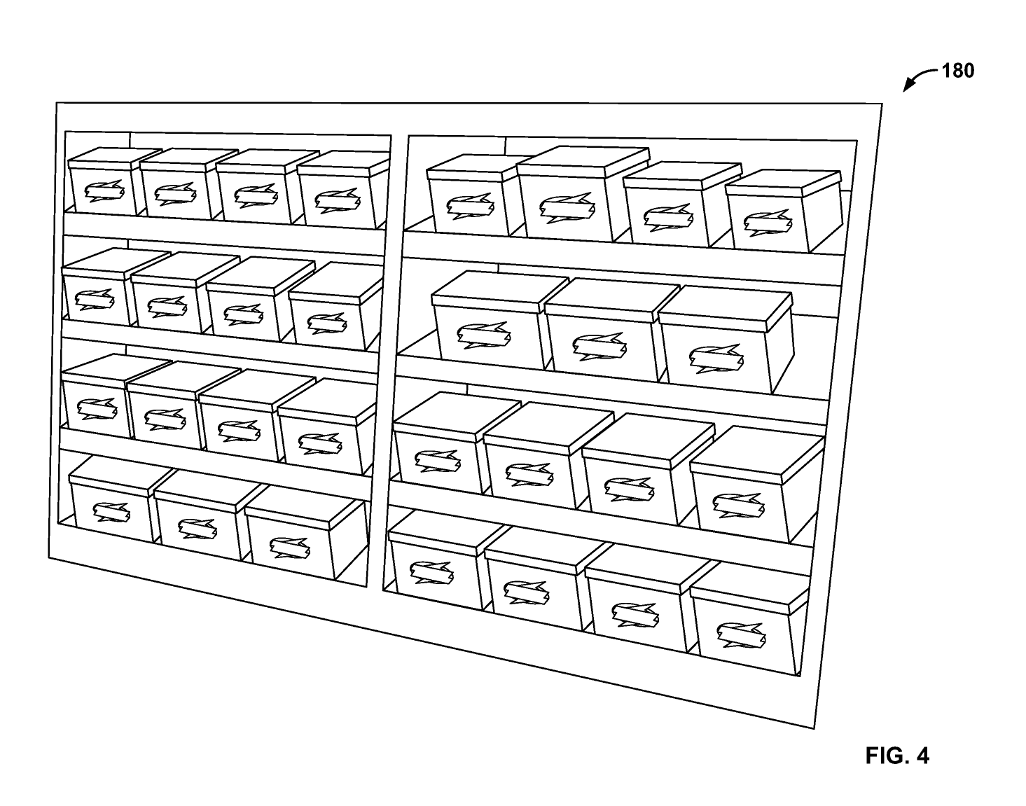

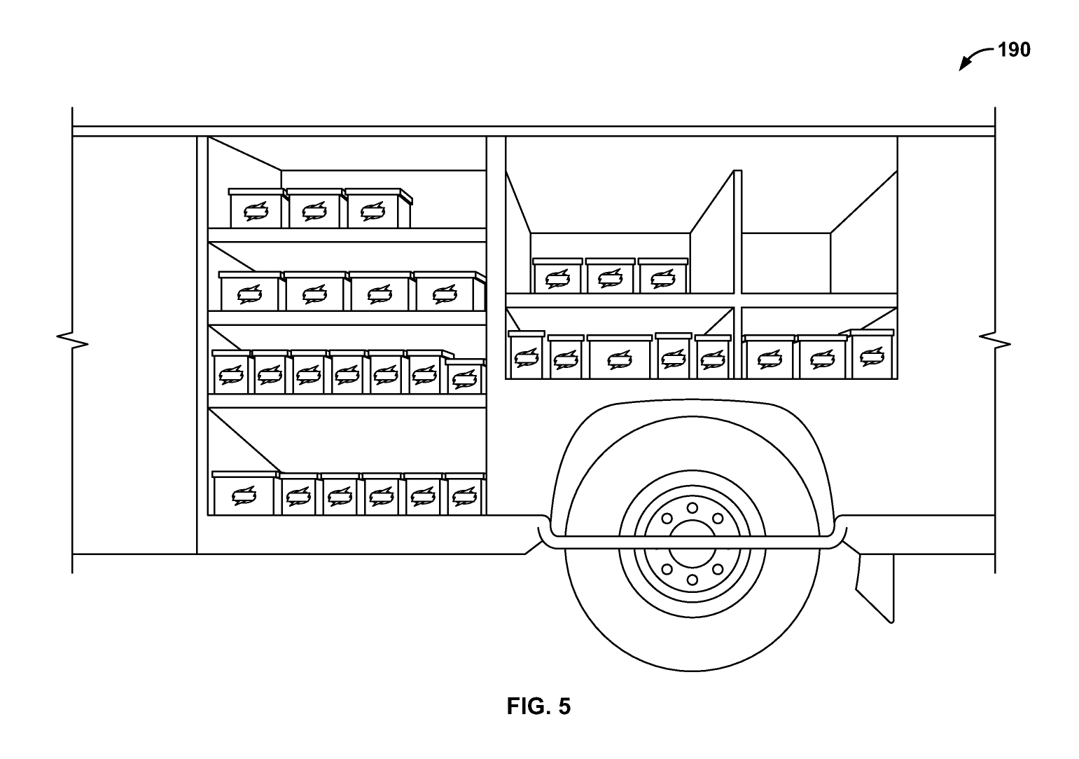

A variety of possible product storage structure 50 configurations can be used in various possible embodiments. In some embodiments, the product storage structure 50 is a retail display, which stores the products 80 for display to potential purchasers in a retail environment, such as a retail store. A specific example of a retail display for batteries is shown in FIG. 4. In another possible embodiment, the product storage system 50 is a transportation structure, such as included within a delivery vehicle or a carrying case. A specific example of a transportation structure is the storage structure of a battery delivery vehicle shown in FIG. 5. Furthermore, the modular nature of the RFID tag scanner allows for unprecedented flexibility in integrating RFID technology into new product storage structures as well as retrofitting the technology into existing structures. This allows for the standardization of antenna placement within a product storage structure, enhancing the precision and accuracy of RFID inventory reads. Furthermore, such a modular design allows for reduction in the labor costs associated with having humans place RFID technology into a product storage structure. Instead of spending a large amount of time and effort placing antennas and routing wires, a laborer can simply install a series of modular functional units. Such a modular design allows for RF validation tests to be performed at a sub-system level on the signal distribution units independently, before placement into the product storage structure. Final system testing can then be performed on the fully-integrated product storage structure with greater efficiency and repeatability.

In the example shown in FIG. 1, the product storage system 50 includes product storage regions 52 (including 52A, 52B, 52C, and 52D) in which the products 80 are at least temporarily stored. In some embodiments, the product storage system 50 includes shelves 54 on which the products 80 are supported in the storage regions 52. In this example, the product storage system 50 includes shelves 54A, 54B, 54C, and 54D that support the products 80 thereon. A top shelf 56 is also included in some embodiments.

The product storage structure 50 is configured to store products 80 thereon. In some embodiments, an RFID tag 90 is physically connected to each product 80, or to packaging for the product 80. In some embodiments, a single RFID tag 90 is associated with multiple products, such as when multiple products 80 are connected together or contained within a single package. The RFID tag 90 is of a type that can be read by the RFID tag scanner 100. An example of a product 80 is a lead-acid battery, such as an automotive or marine battery. A product storage structure 50 that is configured to store batteries is referred to as a battery storage structure.

In some embodiments, the modular RFID tag scanner 100 is designed for quick and easy fastening to an existing product storage structure 50, such as add RFID tag scanning capabilities to a product storage structure 50 that did not previously have such capabilities. The installation of the modular RFID tag scanner 100 onto an existing product storage structure that did not previously have an RFID tag scanner, is referred to as retrofitting of the existing product storage structure. However, use of the modular RFID tag scanner 100 is not limited to retrofitting existing product storage structures, and can also be used in newly constructed or custom designed product storage structures, for example.

Once installed, the modular RFID tag scanner 100 is operable to wirelessly detect the RFID tags 90 on products 80 stored in the product storage structure 100. This information can then be used, for example, to provide up-to-date product inventory data. The product inventory data can be collected and transmitted as frequently as desired, such as every second, minute, hour, 12 hours, day, week, month, quarter, year, etc., or any multiple thereof. The frequency can be chosen based in part on one or more of the following factors: (1) how frequently products are expected to be added or removed from the product storage structure 50, (2) the frequency at which product replenishment can occur, and (3) the desired battery life because increased frequency will result in decreased battery life.

As discussed above, the modular RFID tag scanner 100 includes signal distribution units and a control unit 104.

In some embodiments, the signal distribution units 102 are enclosed modular structures including multiple antennas of a type suitable for generating and receiving RF signals, and operate to detect the presence of RFID tags 90 within an associated product storage region 52. In some embodiments, antennas of the signal distribution units 102 are directional antennas, which generate an RF radiation pattern having a main lobe in a direction D (including D1, D2, D3, and D4, for each of the respective signal distribution units 102). In other words, the strength of the RF radiation is much larger in the direction D (vertically down in FIG. 1) than, at least, in the direction opposite to direction D (vertically up in FIG. 1).

Due to the directionality of some embodiments of the signal distribution units 102, the signal distribution units 102 are configured to be installed onto the product storage structure so that the radiation pattern is directed toward the respective product storage region 52.

As one example, the signal distribution unit 102A is inserted within the product storage region 52A and oriented so that the radiation pattern is directed toward the shelf 54A on which products 80 can be stored. More specifically, the signal distribution unit 102A is arranged at or near the top of the product storage region 52A (connect to or near the top shelf 56), and is oriented so the radiation pattern direction Dl is directed vertically down toward shelf 54A. In some embodiments, the signal distribution units 102B, 102C, and 102D, are similarly arranged within the respective product storage regions 52B, 52C, and 52D.

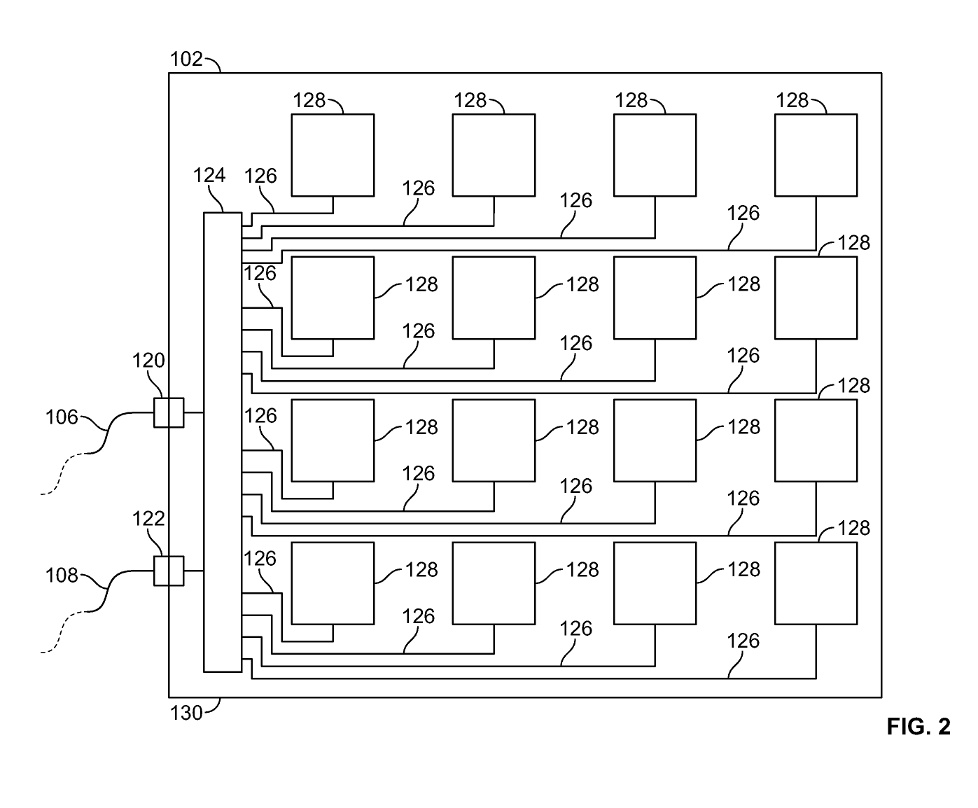

Examples of the signal distribution unit 102 are illustrated and described in more detail herein with reference to FIG. 2.

Fasteners 110 are provided to connect the signal distribution units 102 to the product storage structure 50. The fasteners 110 can include one or more of mounting brackets, flanges, clips, screws, nails, adhesive, and the like. In some embodiments at least part of the fastener is integrally formed with the housing of the signal distribution unit, which may be configured to include appropriate flanges, protrusions, clips, etc. In another possible embodiment, the fasteners 110 are separate pieces that are sized and shaped to mount the signal distribution units 102 to the product storage structure 50. Different fasteners 110 can be used for connecting the signal distribution units 102 with different product storage structures.

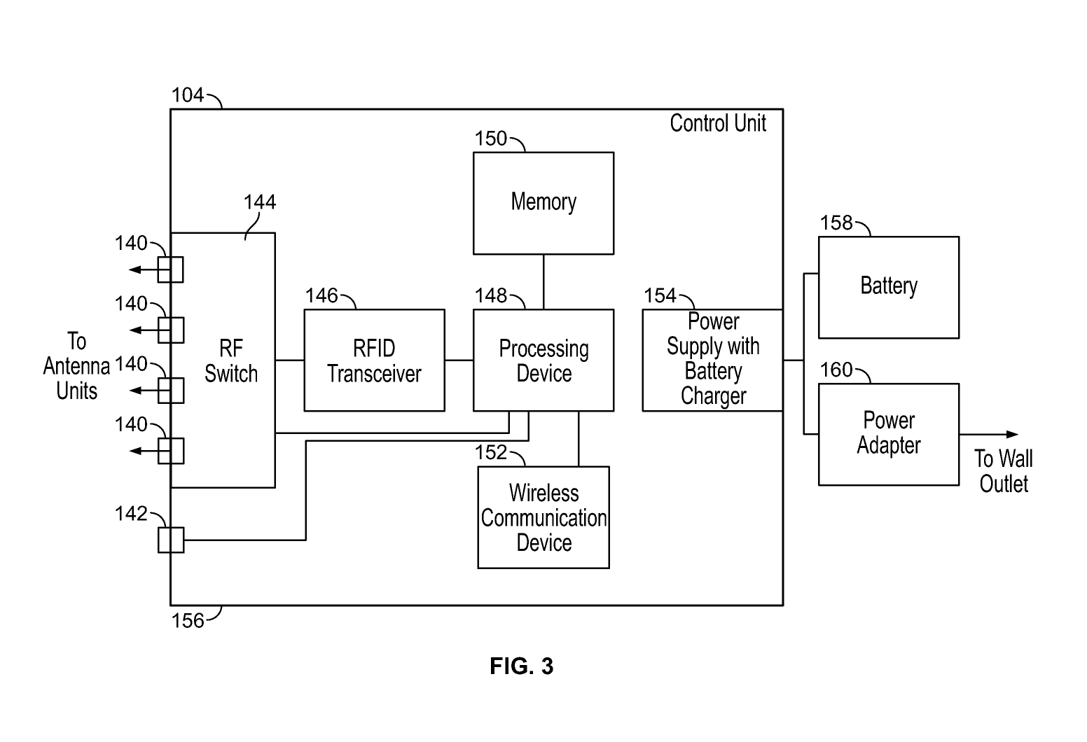

The control unit 104 operates to control the signal distribution units 102, as well as to communicate product inventory data to a remote system, such as to another computing device. The signal distribution units 102 are controlled by the control unit 104 so as to detect RFID tags 90 on products 80 within the respective storage regions 52. A single control unit 104 can be connected with multiple signal distribution units 102, so that inventory within multiple product storage regions 52 can be monitored, for example. The control unit 104 is illustrated and described in more detail herein with reference to FIG. 3. The control unit can be connected to the product storage structure with a fastener.

In some embodiments, the signal distribution units 102 and the control unit 104 are connected by cables or other electrical conductors. In this example, the conductors include RF transmission lines 106 and control wires 108.

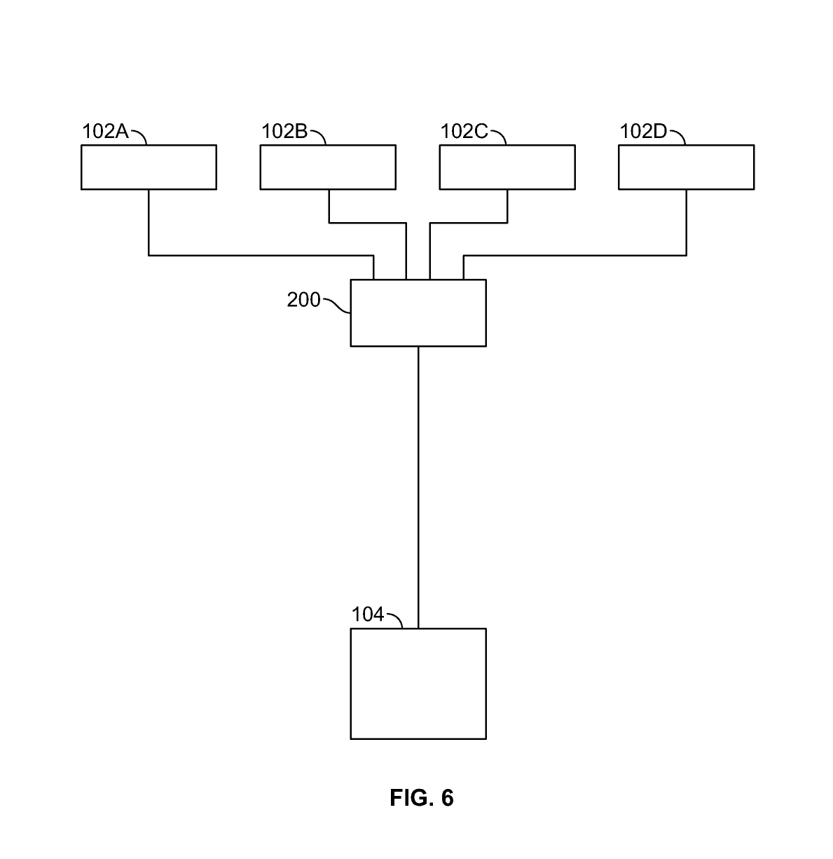

The RF transmission lines 106 are used to transfer RF signals between the signal distribution units 102 and the control unit 104. In some embodiments, each signal distribution unit 102 is connected to the control unit 104 by a single RF transmission line 106. For example, signal distribution unit 102A is connected to control unit 104 with RF transmission line 106A, signal distribution unit 102B is connected to control unit 104B with RF transmission line 106B, etc. In some embodiments, the RF transmission lines 106 are coaxial cables. In some embodiments, the RF transmission lines 106 are lower cost transmission lines. The transmission lines can be lower cost due to the shorter length required by these transmission lines due to the RF switch provided in the control unit 104. In some embodiments the control wiring is arranged in a daisy chain configuration to connect the control unit 104 with the plurality of signal distribution units 102. For example, each control unit 104 includes a control signal input port and a control signal output port. A control wire 108 is connected from the control unit 104 to an input port of a first signal distribution unit 102D, and then connected in a daisy chain configuration to the other signal distribution units 102C, 102B, and 102A by connecting wires from the output port of that signal distribution units 102D to the input port of the next sequential module 102C, and so on. In another embodiment, as illustrated in FIG. 6, one or more intermediary switches 200 are arranged and configured to form RF pathways and/or control signal pathways between the control unit 104 and the signal distribution units 102. Using a daisy chain configuration or intermediary switches can reduce the total length and number of the cables or cords used to form the RF pathways and/or control signal pathways between the control unit and the signal distribution units. Additionally, a daisy-chain configuration or intermediary switches can make it easier to install the control unit and the signal distribution units by permitting the signal distribution units to be connected to each other, rather than having to run additional cables or transmission lines all the way back to the control unit. Cost and space savings is also achieved.

The control wires 108 are used to communicate control signals from the control unit 104 to the signal distribution units 102. One or more control wires 108 are used. In some embodiments, the control wires 108 are used by the control unit 104 to control RF switches within the signal distribution units 102. The control signals are used to select a single antenna within the signal distribution unit 102 at a time. RF signals provided through the RF transmission line 106 are then directed to that antenna, which is also used to detect return signals from the RFID tag 90 and communicate the return signals to the control unit 104. As illustrated in FIG. 1, in some embodiments the signal distribution units 102 are connected to the control unit 104 in a daisy chain configuration. In another embodiment, as illustrated in FIG. 6, one or more intermediary switches 200 can be used to connect the control unit 106 to the signal distribution units 102. As described above, a daisy chain configuration and/or the use of intermediary switches can be advantageous to reduce the length and number of the cables and the labor for installation.

Typically the control unit 104 is operated to cycle through all of the antennas within the signal distribution unit 102, and the antennas of every other signal distribution unit 102 that is controlled by the control unit 104. Through this process, the control unit 104 receives the product identification information from each of the RFID tags 90 on the product storage system 50.

The resulting data, including the product identification information, is typically transmitted from the control unit 104 to a remote server, such as by using a cellular communication device. The resulting data can be processed at the server to identify the location of inventory (e.g., the product storage region 52 in which the product is located). This processing can include, for example, evaluation of signal strengths (where a stronger signal strength indicates a closer proximity of the RFID tag 90 to the signal distribution unit than a weaker signal strength), and elimination of duplicate readings.

FIG. 2 is a schematic cross-sectional diagram illustrating the components of an exemplary signal distribution unit 102 (e.g., 102A, shown in FIG. 1). In this example, the signal distribution unit 102 includes an RF transmission line connector 120, a control wire connector 122, an RF switch 124, antenna transmission lines 126, antennas 128, and a housing 130.

The RF transmission line connector 120 is configured to be connected to the RF transmission line 106 (e.g., 106A, shown in FIG. 1). The RF transmission line connector 120 permits removable attachment of the RF transmission line 106 to the signal distribution unit 102. In another possible embodiment, the RF transmission line 106 can be permanently connected to the signal distribution unit 102. RF signals are transmitted along the shielded RF transmission line and through the RF transmission line connector 120. A ground connection is also made in some embodiments to improve shielding of the RF transmission line from interference.

The control wire connector 122 is configured to be connected to the control wires 108. The control wire connector 122 permits removable attachment of the control wires 108 to the signal distribution unit 102. In another possible embodiment, the control wires 108 can be permanently connected to the signal distribution unit. The control wires 108 can include one or more electrical conductors.

In some embodiments, the RF switch 124 is a one-to-many (e.g., 1:16) switch that permits the control unit 104 to be selectively connected to a single antenna 128 at a time. The RF switch 124 is electrically coupled to the control wire connector 122 to receive control signals from the control unit 104. The control signals selectively connect the conductor from the RF connector 120 to one of the antenna transmission lines 126. While various numbers of antennas can be used in different embodiments, in this example the RF switch 124 includes 16 pins for connection with up to 16 antennas. A larger or smaller switch can be used in other embodiments.

The antenna transmission lines 126 are provided to connect the antennas 128 to the RF switch 124. In some embodiments, the antenna transmission lines 126 are different types of transmission lines than the RF transmission line 106. For example, in some embodiments the antenna transmission lines 126 are higher loss coaxial transmission lines than the RF transmission line 106. Higher loss transmission lines are typically less expensive than lower loss transmission lines. However, because of the relatively short lengths of the antenna transmission lines 126 required within the signal distribution units 102, the higher loss does not significantly impact the quality of the overall signal sent over the RF transmission lines 106 to the control unit 104.

The signal distribution unit 102 includes one or more antennas 128. The antennas are of a type suitable for emitting and receiving RF signals to receive product identification information from RFID tags 90 on products 80 (shown in FIG. 1). As shown in FIG. 2, the antennas are typically arranged in a common plane, and spaced from each other. The spacing and arrangement of the antennas permits RF signals to be generated at different locations about the respective product storage region 52 (e.g., 52A, shown in FIG. 1). This greatly reduces the chance of non-detection of an RFID tag 90, by permitting the control unit 104 to attempt to detect the RFID tag 90 from multiple locations using different antennas 128. The signal distribution unit 102 can have a variety of spacing and arrangement of the antennas so that it has flexible and extensible antenna coverage.

A variety of possible antennas 128 can be used, provided that the antennas 128 are suitable for communicating with the RFID tags 90. As one example, the antenna may have one or more of the following characteristics: dimensions of approximately 6″ by 6″ by 3/16″; a FR4 substrate; a center frequency of about 915 MHz; a bandwidth of about 80 MHz; a voltage standing wave ratio (VSWR) of about −25 dB; and circularly polarized. Other embodiments have antennas 128 with other characteristics. An example of antenna 128 is the Eye antenna available from Seeonic, Inc. in Plymouth, Minn..

The housing 130 is provided to enclose and protect components of the signal distribution unit 102. In some embodiments, the housing encloses at least the switch 124, transmission lines 126, and antennas 128 therein. The RF connector 120 and control wire connector 122 can be arranged outside, inside, or partially inside of the housing 130. Other embodiments can have other configurations. In particular, although the exemplary signal distribution unit 102 is shown having a substantially square cross-sectional shape, and a four-by-four arrangement of antennas 128, other shapes and configurations can be used. For example, an elongated rectangular shape can be used for a storage region 52 having such a shape, and the antennas may be arranged in a two-by-sixteen arrangement. Other quantities of antennas can also be used in other embodiments. The housing 130 is typically made of a non-conductive material, such as plastic.

FIG. 3 is a schematic block diagram of an example of the control unit 104. In this example, the control unit 104 includes RF connectors 140, a control wire connector 142, an RF switch 144, an RFID transceiver 146, a processing device 148, memory 150, a wireless communication device 152, a power supply 154, and a housing 156. Also illustrated in FIG. 3 is a battery 158 and a power adapter 160, which can be included within or exterior to the housing 156 in various embodiments.

The RF connectors 140 are configured to be connected to the RF transmission line 106 (e.g., 106A-106D, shown in FIG. 1). In some embodiments the RF connectors 140 permit removable attachment of the RF transmission lines 106 to the control unit 104. In other embodiments, the RF transmission lines 106 are permanently connected to the control unit 104. An example of an RF connector 140 is a coaxial cable connector. The conductors of the RF connectors 140 are electrically coupled to the RF switch 144.

The control wire connector 142 is configured to be connected to the control wires 108 (shown in FIG. 1). The control unit 104 can include one or more control wire connectors 142. The control wires 108 can be releasably attachable to the control wire connector 142, or permanently attached in different embodiments.

In some embodiments, the RF connectors 140, control wire connector 142, RF transmission lines 106, and control wires 108 (or one or both ends thereof) are all color coded to ensure proper connection of the transmission lines with the appropriate connectors. For example, a first of the RF connectors can be colored with a first color, and a transmission line (e.g., 106A) colored with the same first color. The corresponding RF connector 120 on the signal distribution unit 102 (FIG. 2) can be similarly colored with the same first color. Other RF connectors and transmission lines are colored with a different color. This color coding shows that the signal distribution unit 102A should be connected by the RF transmission line 106A to the first RF connector 140 on the control unit, and reduces the chance of incorrect connection of the cables with the signal distribution units and control unit 104.

The RF switch 144 is electrically coupled to the RF connectors 140 to communicate RF signals to and from the RF transmission lines 106. The RF switch is controlled by the processing device 148, which operates in some embodiments to select one of the signal distribution units 102 (102A-102D) for communication at a time. The RF switch is also connected to the RFID transceiver 146 by a RF transmission line suitable for transmitting the RF signals therebetween. An example of the RF switch 144 is the WideVision switch available from Seeonic, Inc. in Plymouth, Minn..

The RFID transceiver 146 operates under the control the processing device 148 to generate and transmit RF signals across the RF transmission lines 106 to a selected antenna 128 (FIG. 2) of a selected signal distribution unit 102, and also to receive return RF signals from the RFID tags 90. An example of the RFID transceiver 146 is the 82000 chip set from Impinj of Seattle, Wash..

The processing device 148 controls the overall operation of the control unit 104. The processing device 148 can be any processing device operable to execute program instructions, such as a microprocessor or microcontroller. A specific example of the processing device 148 is a 32-bit PIC microcontroller available from Microchip Technologies Inc. of Chandler, Ariz..

The control unit 104 also includes a memory device 150, which may be part of the processing device 148 or separate from the processing device 148. An example of the memory device 150 is Random Access Memory (RAM), such as 16 Mbyte DRAM available from Micron Technology, Inc. of Boise, Id.. Other computer readable storage devices are used in other embodiments. Computer readable storage devices do not include communication media, such as transitory media that conduct signals on communication lines and cables.

In some embodiments, the control unit 104 includes a wireless communication device 152, which is electrically coupled to (or at least in data communication with) and controlled by the processing device 148. In some embodiments, the wireless communication device 154 is a cellular communication device, suitable for communicating data across a cellular communication network. Examples of the wireless communication device 152 include the PHS8 (for GSM) and the PVS8 (for CDMA) communication modules available from Cinterion Wireless Modules GmbH of Munich Germany. Other examples are the Wi-Fi electronics module, MRF24WB0 Wi-Fi I/O, available from MicroChip, a Local Area Network module, TS3L501E-16-Bit to 8-Bit Multiplexer/Demultiplexer Gigabit Ethernet LAN Switch with Power Down Mode available from National Semiconductor, and a Power-Over-Ethernet module, LM5071 Power Over Ethernet PD Controller with Auxiliary Power Interface, from National Semiconductor.

The power supply 154 provides power to the various components of the control unit 104. In some embodiments, the power supply 154 includes a battery charger that operates to charge the battery 158 when connected to an external power source, such as through the power adapter 160. An example of the battery charger is the LTC2950IDDB-2#TRMPBF-IC, Push Button On/Off Controller power supply available from Linear Technology, Inc. of Milpitas, Calif..

The housing unit 156 protects the antennas from environmental influences and allows for easy retrofit into existing product storage systems. In some embodiments, the housing unit 156 provides a method to switch RF signals from single lower loss transmission lines to a plurality of higher loss transmission lines. This provides a less expensive and less complex method of supporting many antennas yet having less than a 10% loss of the RF signal into the product storage system 100 from the control unit 104.

The battery 158 can be included within or external to the housing 156. An example of a battery is a 12V sealed lead acid battery. Other embodiments utilize other batteries. The battery is coupled to the power supply 154 to provide power to the control unit 104 and for recharging when the power supply 154 is connected to an external power source, such as a wall outlet.

A power adapter 160 is provided in some embodiments to permit the control unit 104 to be connected to the external power source. The power adapter typically includes an AC to DC converter, which converts the external power to a desired DC power, such as 12V DC.

FIGS. 4 and 5 illustrate additional examples of product storage systems 50 in which aspects of the present disclosure can be implemented, and more specifically shows examples of product storage systems 50 on which the modular RFID tag scanner 100 can be installed.

FIG. 4 illustrates an example of a retail battery storage structure 180 storing batteries. The storage structure 180 includes shelving defining product storage regions. In order to monitor the inventory of the batteries, the signal distribution units 102 can be installed below the respective shelves and above the batteries, for example. The control unit can be connected at a convenient location, such as to a side or rear of the storage structure 180. The RFID tag scanner 100 can then be used, for example, to monitor the inventory of batteries on the retail battery storage structure 180.

FIG. 5 illustrates an example of a transportation structure in the form of a delivery vehicle. The delivery vehicle includes a storage compartment including shelving defining product storage regions. The signal distribution units 102 can be installed within the product storage regions, and the control unit connected at any suitable location. The modular RFID tag scanner 100 can therefore be used, for example, to monitor the inventory of batteries within the delivery vehicle 190.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A modular radio frequency identification (RFID) tag scanner for a product storage structure, the scanner comprising:
one or more signal distribution units comprising:
a switching device;
antennas configured to wirelessly communicate with RFID tags on products stored in the product storage structure;
antenna transmission lines connecting the antennas to the switching device; and
a housing enclosing the switching device, antennas, and radio frequency (RF) transmission lines therein; and
fasteners configured to connect the one or more signal distribution units to the product storage structure adjacent the products;
one or more control wires configured to be electrically coupled to each of the one or more signal distribution units;
a control unit operable to control the switching devices through the control wires to selectively communicate with the antennas of the one or more signal distribution units and to detect RFID tags on products stored in the product storage structure; and
one or more RF transmission lines configured to be connected between the signal distribution units and the control unit.

2. A method of installing an RFID tag scanner on a product storage structure having product storage regions, the method comprising:
inserting signal distribution units into each of the product storage regions and fastening the signal distribution units with a fastener, wherein the signal distribution units include multiple antennas, antenna transmission lines connected to each antenna, and an RF switch all contained within a housing;
connecting a control unit to the product storage structure; and
connecting RF transmission lines and control wires between the control unit and the signal distribution units.
